(19) United States
(12) Patent Application Publication
(10) Pub. No.: US 2008/0232590 A1
(43) Pub. Date: Sep. 25, 2008

(54) Micropayment Processing Method and System

(76) Inventors: Ronald L. Rivest, Arlington, MA (US); Silvio Micali, Brookline, MA (US); Perry Solomon, Pawtucket, RI (US); Robert Nix, Concord, MA (US); Robert Carney, Cambridge, MA (US); Prasad Jonnalagadda, Newton, MA (US); Joseph Bergeron III, Boston, MA (US); Mark Bates, Malden, MA (US)

Correspondence Address: PERKINS COIE LLP;PATENT-SEA, P.O. BOX 1247, SEATTLE, WA, 98111-1247, US

(21) Appl. No.: 10/553,611

(22) PCT Filed: Jan. 23, 2004
(86) PCT No.: PCT/US04/01845

§ 371 Date: Jan. 8, 2008

Related U.S. Application Data
(60) Provisional application No. 60/456,741, filed on Mar. 21, 2003.
(60) Provisional application No. 60/442,486, filed on Jan. 25, 2003.

(51) Int. Cl. H04L 9/14; H04L 9/00; G06Q 20/00

(52) U.S. Cl. 380/277; 705/75; 705/50

(57) ABSTRACT

A method of producing an offer package includes defining, within the offer package, a description of an offered product. The cost of the offered product and the merchant making the offer are also defined within the offer package, which includes an encrypted version of the offered product.

### RELATED APPLICATIONS

This application claims the benefit of priority to: (a) U.S. Provisional Application No. 60/442,486, filed 25 Jan. 2003, entitled “Method and System for Micropayment Transactions”; (b) U.S. Provisional Application No. 60/456,741, filed 21 Mar. 2003, entitled “Method and System for Micropayment Transactions”; and (c) U.S. patent application Ser. No. 10/476,128, filed 27 Oct. 2003, entitled “Method and System for Micropayment Transactions”, which claims the benefit of priority to International Application No.: PCT/US02/12189 (filed 17 Apr. 2002), which claims the benefit of priority to U.S. Provisional Application No. 60/287,251 (filed 27 Apr. 2001), U.S. Provisional Application No. 60/306,257 (filed 18 Jul. 2001), and U.S. Provisional Application No. 60/344,205 (filed 26 Dec. 2001)

### FIELD OF THE INVENTION

This invention relates to transaction processing and, more particularly, to the processing of micropayment transactions.

### BACKGROUND

Now that the era of free-internet-content is drawing to a close, consumers want pay-per-use options to complement internet subscription availability. While digital content owners recognize the potential of pay-per-use models (i.e., for items such as games, music, and software), existing payment systems for low-value digital content are characterized by high transaction costs, which in some cases exceed the value of the digital content itself.

Often, banks and payment processors levy a minimum transaction fee (i.e., typically at least $0.20) for every digital content transaction, even those transactions with very low price points.

Unfortunately, these minimum transaction fees constitute a significant barrier to profitability for low-priced transactions, and have inhibited the growth of markets that distribute low-priced content.

### SUMMARY OF THE INVENTION

In one implementation, a method of producing an offer package includes defining, within the offer package, a description of an offered product. The cost of the offered product and the merchant making the offer are also defined within the offer package, which includes an encrypted version of the offered product.

One or more of the following features may also be included. A use duration for the offered product may be defined within the offer package. A currency of the offer may be defined within the offer package. An expiration date of the offer may be defined within the offer package. The offer package may be digitally signed and the offered product may be encrypted to generate the encrypted-version of the offered product.

In another implementation, a method of producing an offer package includes defining, within the offer package, a description of an offered product/service. The cost of the offered product/service and the merchant making the offer are also defined within the offer package, which includes an encrypted link to the offered product/service.

One or more of the following features may also be included. A use duration for the offered product/service may be defined within the offer package. A currency of the offer may be defined within the offer package. An expiration date of the offer may be defined within the offer package. The offer package may be digitally signed. A link to the offered product/service may be encrypted to generate the encrypted link.

In another implementation, a method of reducing download fraud includes defining an offer package, such that the offer package includes a offer description and an encrypted version of the offered product, and requiring that a potential consumer download the offer package prior to being able to review the offer description.

One or more of the following features may also be included. The potential consumer may be required to download the offer package prior to being able to purchase the offer package. The potential consumer may be allowed to decrypt the encrypted version of the offered product in response to the potential consumer purchasing the offer package. The potential consumer may be provided with a decryption key that allows the potential consumer to decrypt the encrypted version of the offered product.

In another implementation, a method of processing an offer package includes validating the offer package, accepting the offer package, determining a cumulative spend amount for the consumer that accepted the offer package, and generating a micropayment token that identifies the offer package and the cumulative spend amount.

One or more of the following features may also be included. An offer description included within the offer package may be reviewed prior to accepting the offer package. The micropayment token may be digitally signed. The micropayment token may be transmitted to a token processing system. A decryption key may be received from the token processing system.

The offer package may concern an offered product, and the offer package may include an encrypted version of the offered product. The decryption key may allow the consumer to decrypt the encrypted version of the offered product.

The offer package may concern an offered product/service, and the offer package may include an encrypted link to the offered product/service. The decryption key may allow the consumer to decrypt the encrypted link.

A consumer certificate, concerning the consumer that accepted the offer package, may be obtained from a token processing system. The consumer certificate may include a consumer identifier that allows for the retrieval of the cumulative spend amount. The offer package may be retrieved from a remote location.

In another implementation, a method of processing micropayment tokens includes receiving a micropayment token from a remote source. The micropayment token concerns an offer package that was offered by a merchant and accepted by a consumer. The micropayment token is validated, accepted for processing, and selected for micropayment processing.

One or more of the following features may also be included. A decryption key may be transmitted to the consumer. The offer package that was offered by the merchant and accepted by the consumer may be validated. The offer package may be verified to have not expired.

The accepted micropayment tokens may be defined as either selected micropayment tokens or unselected micropayment tokens, such that the selected micropayment tokens are used as the basis for paying a macropayment amount to the merchant. The accepted micropayment tokens may be defined in accordance with a defined selection percentage. The defined selection percentage may be one percent (i.e., resulting in one selected micropayment token for each ninety-nine unselected micropayment tokens) or may be ten percent (i.e., resulting in one selected micropayment token for each nine unselected micropayment tokens).

Each selected micropayment token may define a micropayment token amount. The micropayment token amount may be increased in accordance with the inverse of the defined selection percentage, thus defining the macropayment amount. The micropayment token may be digitally signed.

In another implementation, a method of processing selected micropayment tokens includes validating a selected micropayment token, and queuing the selected micropayment token. The selected micropayment token defines a macropayment amount, defines a micropayment token amount, and concerns an offer package that was offered by a merchant and accepted by a consumer.

One or more of the following features may also be included. The offer package that was offered by the merchant and accepted by the consumer may be validated. The offer package may be verified to have not expired. The selected micropayment token may be placed into a processing queue, such that a queue reserve is associated with the processing queue. The processing queue may be a FIFO queue. Each selected micropayment token may further define a cumulative spend amount, which is the sum of: the last amount previously billed to the consumer; and the differential amount that the consumer has spent since the last billing.

A consumer banking institution that is associated with the consumer may be billed for the sum of the micropayment token amount and the differential amount. The last amount previously billed to the consumer may be set equal to the sum of: the last amount previously billed to the consumer; the differential amount; and micropayment token amount. The differential amount may be set equal to zero. The sum of the micropayment token amount and the differential amount may be deposited into the queue reserve associated with the processing queue. The macropayment amount of a next-to-be-processed selected micropayment token within the processing queue may be compared to the value of the queue reserve. The next-to-be-processed selected micropayment token may be the selected micropayment token in the front position of the processing queue. The macropayment amount defined in the next-to-be-processed selected micropayment token may be deposited into a merchant banking institution associated with the merchant.

In another implementation, a method of processing unselected micropayment tokens includes authorizing for processing an unselected micropayment token, and validating the unselected micropayment token. The unselected micropayment token defines a micropayment token amount, a cumulative spend amount, and concerns an offer package that was offered by a merchant and accepted by a consumer. The cumulative spend amount is the sum of: a last amount previously billed to the consumer; and a differential amount that the consumer has spent since the last billing.

One or more of the following features may also be included. The offer package that was offered by the merchant and accepted by the consumer may be validated. The offer package may be verified to have not expired. The unselected micropayment token may be placed into a processing queue. A queue reserve may be associated with the processing queue. The processing queue may be a FIFO queue.

A consumer banking institution that is associated with the consumer is billed for the sum of the micropayment token amount and the differential amount. The last amount previously billed to the consumer may be set equal to the sum of: the last amount previously billed to the consumer; the differential amount; and micropayment token amount. The differential amount may be set equal to zero. The sum of the micropayment token amount and the differential amount may be deposited into the queue reserve associated with the processing queue.

A predetermined time period (e.g., thirty days) may be compared to an actual time period since the unselected micropayment token was generated, such that the unselected micropayment token is authorized for processing if the actual time period exceeds the predetermined time period. A predefined minimum billing threshold (e.g., five dollars) may be compared to the differential amount, such that the unselected micropayment token is authorized for processing if the differential amount exceeds the predetermined time period.

In another implementation, a batch encoding method includes defining a batch size definition and obtaining two or more data objects that satisfy the batch size definition. Each data object is hashed to generate an N^{th} order hashed data object for each data object. The N^{th} order hashed data objects are grouped into one or more pairs of N^{th} order hashed data objects. Each pair of N^{th} order hashed data objects are hashed to generate an N^{th+1} order hashed data object for each pair of N^{th} order hashed data objects. The grouping of the N^{th} order hashed data objects and the hashing of each pair of N^{th} order hashed data objects is recursively repeated until there is only one N^{th +1} order hashed data object generated.

One or more of the following features may also be included. The N⁺¹ order hashed data object may be digitally signed. The number of N^{th} order hashed data objects generated may be an odd number, and the grouping of the N^{th} order hashed data objects may result in one or more pairs of N^{th} order hashed data objects and a single N^{th} order hashed data object.

The single N^{th} order hashed data object may be grouped with an M^{th} order hashed data object. The M^{th} order hashed data object may be a higher order hashed data object than the single N^{th} order hashed data object. The single N^{th} order hashed data object may be hashed with the M^{th} order hashed data object to generate an M^{th+1} order hashed data object.

Defining a batch size definition may include defining a time period (e.g., 100 milliseconds). Obtaining two or more data objects may include obtaining data objects made available during the time period. Defining a batch size definition may include defining a number of data objects. The data object may be a micropayment token (e.g., a selected micropayment token or an unselected micropayment token), or an offer package.

In another implementation, a verification method includes receiving a hashed, multi-level, data object, such that the hashed, multi-level, data object includes one or more hashed, non-target data objects. One or more sequential data keys are received, such that each sequential data key corresponds to a hashed, non-target data object at a unique level within the hashed, multi-level, data object. A non-hashed, target data object is received. The non-hashed, target data object is hashed to generate an N^{th} level hashed data object. The N^{th} level hashed data object is grouped with an N^{th} level, sequential data key to generate an N^{th} level object/keypair. The N^{th} level object/keypair is hashed to generate an N^{th +1} level hashed data object, such that the grouping of the N^{th} level hashed data object and the hashing of the N^{th} level object/key pair are repeated for each sequential data key.

One or more of the following features may also be included. The hashed, multi-level, data object may be an encrypted, hashed, multi-level, data object. The encrypted, hashed, multi-level, data object may be decrypted to generate a decrypted, hashed, multi-level, data object. The decrypted, hashed, multi-level, data object may be compared to the highest-level hashed data object generated to determine the validity of the hashed, multi-level data object.

The non-hashed, target data object may be a micropayment token (e.g., a selected micropayment token or an unselected micropayment token) or an offer package.

In another implementation, a secure payment processing system includes at least one secure module and at least one non-secure module. A plurality of tokens are transferred between the at least one secure module and the at least one non-secure module. At least one of the modules executes a micropayment selection protocol that selects one or more, but not all, of the tokens for processing from the plurality of tokens.

One or more of the following features may also be included. The at least one secure module may include a cPSP module, or an mPSP module. The at least one non-secure module may include a consumer agent module, an offer development module, or a PCS module.

The micropayment selection protocol may establish payment for a transaction T. The protocol may include a first party deriving from T a data string C related to T, and causing a second party to receive at least a portion of the data string C. The protocol may include the second party associating with the at least a portion of C an item V, such that V is substantially unpredictable by the first party. The protocol may include the second party determining whether V satisfies a property P, and if so, the second party causing a third party to receive information I enabling the third party to verify whether V satisfies the property P. The protocol may include the third party, upon receiving I, verifying whether V satisfies the property P, and the third party causing a fourth party to receive an amount A, only if V satisfies the property P.

The micropayment selection protocol may allow a user U to establish payment to a merchant M for a transaction T having a transaction value T_{V}. The protocol may include the user establishing a public key and a corresponding secret key for a first digital signature scheme, and deriving from T a data string C=SIG_{U}(T) to create an electronic check containing C, such that SIG_{U}(T) represents the digital signature of the user U for the transaction T in the first digital signature scheme. The protocol may include the user causing the merchant to receive the data string C. The protocol may include the merchant establishing a public key and a corresponding secret key for a second digital signature scheme, and associating with the data string C an item V=SIG_{M}(C), such that SIG_{M}(C) represents the digital signature of the merchant M for the data string C in the second digital signature scheme. The protocol may include the merchant computing the value F(V)=F(SIG_{M}(C)), where F represents a public function that operates on a bit string to output a number between 0 and 1. The protocol may include the merchant comparing F(SIG_{M}(C)) with a constant s to determine whether F(V)<s, and if so, causing a bank to obtain the public key of the merchant. The protocol may include the bank using the public key of the merchant to verify that F(SIG_{M}(C))<s; and only if F(SIG_{M}(C))<s, the bank causing the merchant to receive an amount A=[T_{V}*1/s]; such that s is a constant greater than 0 and less than 1, and represents the probability that the electronic check be selected for presentation to the bank.

The micropayment selection protocol may establish payment for a transaction T. The protocol may include a first party receiving from a second party at least a portion of a data string C, such that the data string C is related to T. The protocol may include the first party associating with at least a portion of C an item V, such that V is substantially unpredictable by the second party. The protocol may include the first party determining whether V satisfies a property P, and only if so, the first party causing a third party to receive information I enabling the third party to verify whether V satisfies the property P, thereby enabling the third party to cause a fourth party to receive an amount A upon verification that V satisfies P.

The micropayment selection protocol may establish payment for a transaction T. The protocol may include a first party receiving from a second party information I enabling the first party to verify that an item V satisfies a property P, such that the item V is associated with at least a portion of a data string C derived from T by a third party, and such that V is substantially unpredictable by the third party. The protocol may include the first party, upon receiving I, verifying whether V satisfies the property P. The protocol may include the first party causing a fourth party to receive an amount A, only if V satisfies the property P.

The micropayment selection protocol may establish payment for a transaction T characterized in part by a time t. The protocol may include a first party deriving from T a data string C related to T, such that C includes information IN regarding the time t. The protocol may include the first party causing a second party to receive at least a portion of the data string C, such that the at least a portion of C includes information IN. The protocol may include the second party associating with the at least a portion of C an item V, such that V is substantially unpredictable by the first party. The protocol may include the second party determining whether V satisfies a property P, and if so, the second party at time t′ causing a third party to receive information IN and information I enabling the third party to verify whether V satisfies the property P. The protocol may include the third party, upon receiving I, verifying whether V satisfies the property P; and the third party causing a fourth party to receive an amount A, only if: V satisfies the property P, and |t′−t| is less than a predetermined time interval.

The micropayment selection protocol may establish payment for a transaction T. The protocol may include a first party deriving from T a data string C related to T, and causing a second party to receive at least a portion of the data string C. The protocol may include the second party determining whether a property P holds between the at least a portion of C and a quantity Q depending on C, such that Q is substantially unpredictable by the first party, and if so, the second party causing a third party to receive information I enabling the third party to verify that the property P is satisfied. The protocol may include the third party, upon receiving I, verifying whether the property P is satisfied, and only upon verifying that the property P holds between the at least a portion of C and Q, the third party causing a fourth party to receive an amount A.

The micropayment selection protocol may establish payment for a transaction T characterized in part by a time t. The protocol may include a first party deriving from T a data string C related to T. The protocol may include a second party deriving a sequence of values VLᵢ associated with a sequence of times tᵢ (i=1, . . . , n), such that for at least one integer m greater than 1 and less than n, |t−tₘ| is less than a predetermined amount. The protocol may include the first party causing the second party to receive at least a portion of the data string C, such that the portion includes information regarding the time t of the transaction T. The protocol may include the second party determining whether a property P holds between the portion of C, and one of the value VLₘ associated with tₘ, and a quantity Q depending on VLₘ. The protocol may include, if P holds, the second party causing a third party to receive information I enabling the third party to verify that the property P is satisfied. The protocol may include the third party, upon receiving I, verifying whether Q satisfies P. The protocol may include the third party causing a fourth party to receive an amount A, only if Q satisfies the property P.

The micropayment selection protocol may establish payment for a transaction T characterized in part by a transaction t. The protocol may include a first party deriving from T a data string C related to T, such that C includes information regarding t. The protocol may include a second party deriving a sequence of values Vᵢ associated with a sequence of time units tᵢ (i=1, . . . , n); such that each pair of adjacent time units tᵢ₊₁ and tᵢ defines a time interval Δtᵢ=tᵢ₊₁−tᵢ; and such that for at least an integer m greater than 1 and less than n, the time t is within the time interval Δtₘ. The protocol may include at the beginning of the time interval Δtₘ, the second party deriving a value Qₘ associated with Vₘ, such that Qₘ is substantially unpredictable by the first party. The protocol may include during the time interval Δtₘ: the first party causing the second party to receive at least a portion of C; the second party determining whether a property P holds between the portion of C and Qₘ, and if so, the second party causing a third party to receive information I enabling the third party to verify that the property P is satisfied. The protocol may include the third party, upon receiving I, verifying whether Q satisfies P. The protocol may include the third party causing a fourth party to receive an amount A, only if Q satisfies the property P.

The micropayment selection protocol may establish payment for a transaction T characterized in part by a time t. The protocol may include a first party deriving from T a data string C related to T, such that C includes information F regarding t. The protocol may include a second party deriving a sequence of values xᵢ (i=0, 1, . . . , n) associated with a sequence of time values tᵢ (i=0, 1, . . . , n), and making x₀ public; such that xᵢ=H(xⱼ₊₁) for i=0, 1, . . . , n−1, where H is a one-way hash function, such that each pair of adjacent time values tᵢ₊₁ and tᵢ defines a time interval Δtᵢ=tᵢ₊₁−tᵢ; and such that for at least an integer m greater than 1 and less than n, the time t is the time interval Δtₘ. The protocol may include during the time interval Δtₘ, the first party causing the second party to receive at least a portion of C, such that the portion includes F. The protocol may include during the time interval Δtₘ, the second party determining whether a property P holds between Qₘ and the portion of C, and if so, the second party causing a third party to receive information I enabling the third party to verify that the property P is satisfied. The protocol may include the third party, upon receiving I, verifying whether Qₘ satisfies P. The protocol may include the third party causing a fourth party to receive an amount A, only if Q satisfies the property P.

The micropayment selection protocol may establish payment for a transaction T characterized in part by a time t. The protocol may include a first party receiving from a second party at time t′ information I enabling the first party to verify that an item V satisfies a property P, such that the item V is associated with at least a portion of a data string C that is derived from T by a third party and that includes information regarding t, such that V is substantially unpredictable by the third party. The protocol may include the first party, upon receiving I, verifying whether V satisfies the property P; and C. The protocol may include the first party causing a fourth party to receive an amount A, only if: a) V satisfies the property P; and |t′−t| is less than a predetermined amount.

The micropayment selection protocol may establish payment for a transaction T characterized in part by a time t. The protocol may include a first party receiving from a second party at least a portion of a data string C, such that the data string C is related to T, and such that the portion of C includes information on t. The protocol may include the first party associating with the at least a portion of C an item V, such that V is substantially unpredictable by the second party. The protocol may include the first party determining whether V satisfies a property P, and if so, the first party at a time t′ causing a third party to receive information I enabling the third party to verify whether V satisfies the property P, thereby enabling the third party to cause a fourth party to receive an amount A, provided that V satisfies P; and |t′−t| is less than a predetermined amount.

The micropayment selection protocol may establish payment for a plurality of n transactions T₁, T₂, . . . Tᵢ, . . . Tₙ, such that an index i, between 1 and n, can be associated with each Tᵢ, and such that each transaction Tᵢ is characterized in part by a transaction value TVᵢ. The protocol may include a first party using a probabilistic payment scheme to generate a check Cᵢ for each transaction Tᵢ and causing a second party to receive the Cᵢ, such that Cᵢ includes an indication of the index i. The protocol may include the second party selecting the checks Cⱼ (1≦j≦n) that are payable in a manner that prevents the first party from predicting in advance which checks Cⱼ will be selected to be payable. The protocol may include the second party causing a third party to receive information Iⱼ enabling the third party to verify that a selected check Cⱼ is payable. The protocol may include the third party, in response to receipt of Iⱼ, verifying that a selected check Cⱼ is payable; and only if Cⱼ is payable, a fifth party causing a fourth party to receive a credit amount CRⱼ , and causing the first party to be debited by a debit amount Dⱼ so that, for all index j between 1 and n, and for any selection of payable checks, D=D₁+D₂+ . . . +Dⱼ is no greater than TV_{agg}=TV₁+TV₂+ . . . +TVⱼ.

The micropayment selection protocol may establish payment for a plurality of n transactions T₁, T₂, . . . Tᵢ . . . Tₙ, such that an index i, between 1 and n, can be associated with each Tᵢ, and such that each transaction Tᵢ is characterized in part by a transaction value TVᵢ. The protocol may include a first party deriving from each transaction Tᵢ a data string Cᵢ related to Tᵢ, and causing a second party to receive the data string Cᵢ. The protocol may include the second party associating with each data string Cᵢ an item Vᵢ, such that Vᵢ is substantially unpredictable by the first party. The protocol may include the second party determining whether Vᵢ satisfies a property Pᵢ, and if so, the second party causing a third party to receive information Iᵢ enabling the third party to verify whether Vᵢ satisfies the property Pᵢ; the third party, in response to receipt of Iᵢ, verifying whether Vᵢ satisfies the property Pᵢ. The protocol may include, only if Vᵢ satisfies the property Pᵢ, a fifth party causing a fourth party to receive a credit amount CRᵢ, and causing the first party to be debited by a debit amount Dᵢ; such that the debit amount Dᵢ is less than or equal to the credit amount CRᵢ.

The micropayment selection protocol may pay for a plurality of equal-valued transactions T₁, T₂, . . . Tᵢ, . . . Tₙ, each having a value TV. The protocol may include a first party deriving from each transaction Tᵢ a data string Cᵢ related to Tᵢ, and causing a second party to receive the data string Cᵢ, such that each data string Cᵢ comprises a progressive serial number Sᵢ, the serial number Sᵢ being sequentially ordered starting from 1 and being representative of a position of Cᵢ relative to other data strings in an ordered succession of data strings Cⱼ (j=1, . . . , n). The protocol may include the second party associating with Cᵢ an item Vᵢ, such that Vᵢ is substantially unpredictable by the first party. The protocol may include the second party determining whether a property Pᵢ holds between Cᵢ and Vᵢ, and if so, the second party causing a third party to receive information Iᵢ enabling the third party to verify whether Vᵢ satisfies Pᵢ; D. The protocol may include the third party verifying whether Vᵢ satisfies Pᵢ; and only if Vᵢ satisfies Pᵢ: a fifth party determining the value of Sₘₐₓ, such that Sₘₐₓ represents the largest of any serial number Sₖ contained in Cₖ for which: 1≦k<n; Cₖ is received by second party before receiving Cᵢ. The third party has verified that Vₖ satisfies Pₖ and the first party has been debited by a nonzero amount Dₖ, the fifth party causing a fourth party to receive a credit amount CR. The protocol may include the fifth party causing the first party to be debited by a debit amount Dᵢ, where Dᵢ is given by: (Sᵢ−Sₘₐₓ)*TV.

The micropayment selection protocol may allow a user to establish payment to a merchant M for a plurality of transactions Tᵢ (i=1, . . . , n) having transaction values TVᵢ (i=1, . . . , n). The protocol may include the user U establishing a public key and a corresponding secret key for a first digital signature scheme, and deriving from each Tᵢ a data string Cᵢ=SIG_{U}(Tᵢ) and creating an electronic check CHᵢ that contains Cᵢ and a serial number Sᵢ, such that SIG_{U}(Tᵢ) represents the digital signature of the user Uᵢ for the transaction Tᵢ in the first digital signature scheme, such that Sᵢ is a progressive serial number representative of an order of the data string Cᵢ relative to the other data strings in an ordered succession of data strings Cⱼ (j=1, . . . , n) derived by the first party. The protocol may include the user U causing the merchant M to receive the electronic check CHᵢ containing Cᵢ and Sᵢ. The protocol may include the merchant M establishing a public key and a corresponding secret key for a second digital signature scheme, and associating with the data string Cᵢ an item Vᵢ=SIG_{M}(Cᵢ), such that SIG_{M}(Cᵢ) represents the digital signature of the merchant M for the data string Ci in the second digital signature scheme. The protocol may include the merchant M computing the value F(Vᵢ)=F(SIG_{M}(Cᵢ)), where F represents a public function that operates on a bit string to output a number between 0 and 1. The protocol may include the merchant M comparing F(SIG_{M}(Cᵢ)) with a constant s (0<s<1) to determine whether F(Vᵢ)<s, and if so, causing a bank to obtain the public key of the merchant M. The protocol may include the bank using the merchant's public key to verify that F(SIG_{M}(Cᵢ))<s; and only if F(SIG_{M}(Cᵢ))<s, a fifth party determining the value of Sₘₐₓ, such that Sₘₐₓ represents the largest serial number Sⱼ contained in any CHⱼ in the ordered succession upon which payment was made. The protocol may include the fifth party causing a fourth party to receive a credit amount CR. The protocol may include the fifth party causing the first party to be debited by a debit amount Dᵢ.

The micropayment selection protocol may establish payment for a plurality of n transactions T₁, T₂, . . . , Tᵢ, . . . , Tₙ, such that an index i, between 1 and n, can be associated with each Tᵢ, and such that each transaction Tᵢ is characterized in part by a transaction value TVᵢ. The protocol may include a first party receiving from a second party at least a portion of a data string Ci for each Ti, such that each data string Ci is generated from Ti using a probabilistic payment scheme, and such that each Ci includes an indication of the index i. The protocol may include the first party selecting the checks Cj (j less than or equal to n and greater than or equal to 1) that are payable in a manner that prevents the first party from predicting in advance which checks Cj will be selected as payable. The protocol may include, for each selected check Cj, the first party causing a third party to receive information Ij enabling the third party to verify that the selected check Cj is indeed payable, thereby enabling the third party, upon verification that Cj is payable, to cause a fourth party to receive a credit amount CRj and the second party to be debited by a debit amount Dj so that, for all index j between 1 and n, and for any selection of payable checks Cj, D=D₁+D₂+ . . . Dⱼ is no greater than TV_{agg}=TV₁+TV₂+ . . . +TVⱼ.

The micropayment selection protocol may establish payment for a plurality of n transactions T₁, T₂, . . . , Tᵢ, . . . , Tₙ, such that an index i, between 1 and n, can be associated with each Tᵢ, and such that each transaction Tᵢ is characterized in part by a transaction value TVᵢ and can be represented by a corresponding data string Cᵢ. The protocol may include a first party receiving from a second party information Iⱼ enabling the first party to verify that a check Cⱼ is payable, such that the check Cⱼ is selected by the second party from a plurality of checks Cᵢ (i=1, . . . , n) derived by a third party from a corresponding one of the plurality of transactions Tᵢ (i=1, . . . , n), such that the selection of the check Cⱼ is substantially unpredictable by the third party. The protocol may include the first party, upon receiving Iⱼ, verifying whether Cⱼ is indeed payable. The protocol may include the first party causing a fourth party to receive a credit amount CRᵢ, and causing the third party to be debited by a debit amount Dᵢ,

The micropayment selection protocol may establish payment for a plurality of n transactions T₁, T₂, . . . Tᵢ, . . . Tₙ, such that each transaction Tᵢ is characterized in part by a transaction value TVᵢ that is a multiple of a unit value UV. The protocol may include a first party deriving from each transaction Tᵢ a data string Cᵢ corresponding to Tᵢ, and causing a second party to receive Cᵢ, such that each data string Cᵢ includes information on the integer index i and the value TVᵢ of Tᵢ in the form of a vector (Sᵢ, Sᵢ+vᵢ−1), such that for all i between 1 and n, Sᵢ is a progressive serial number that is sequentially ordered and that is representative of a position of Cᵢ relative to other data strings in an ordered succession of data strings Cⱼ (j=1, . . . , n), and such that vᵢ is an integer depending on i and indicative of the value TVᵢ of Tᵢ, and is given by vᵢ=TVᵢ/(UV). The protocol may include the second party selecting the checks Cⱼ (1≦j≦n) that are payable in a manner that prevents the first party from predicting in advance which checks Cⱼ will be selected to be payable. The protocol may include the second party causing a third party to receive information Iⱼ enabling the third party to verify that a selected check Cⱼ is payable. The protocol may include the third party, in response to receipt of Iⱼ, verifying that a selected check Cⱼ is payable. The protocol may include, only if Cⱼ is payable, a fifth party determining the value of Sₘₐₓ, such that max is an integer such that 1≦max<i≦n, and vₘₐₓ=TVₘₐₓ/(UV), and such that Sₘₐₓ represents the largest of any serial number Sₖ (1≦k<n) contained in Cₖ for which: Cₖ is received by the second party before receiving Cᵢ; and the third party has verified that Vₖ satisfies Pₖ; and the first party was debited by a non-zero amount Dₖ, and the fifth party causing a fourth party to receive a credit amount CR. The protocol may include the fifth party causing the first party to be debited by a debit amount Dᵢ, where Dᵢ is given by: (Sᵢ+vᵢ−1−Sₘₐₓ)*UV.

The micropayment selection protocol may establish payment for a plurality of n transactions T₁, T₂, . . . Tᵢ, . . . Tₙ, such that an index i between 1 and n is associated with each Tᵢ, and such that each transaction Tᵢ is characterized in part by a transaction value TVᵢ that is an integral multiple of a unit value UV. The protocol may include a first party deriving from each transaction Tᵢ a data string Cᵢ corresponding to Tᵢ and causing a second party to receive Cᵢ, such that each data string Cᵢ includes information on the integer index i and the value TVᵢ of Tᵢ in the form of a vector (Sᵢ, Sᵢ+vᵢ−1), such that for all i between 1 and n, Si is a progressive serial number that is sequentially ordered and that is representative of a position of Cᵢ relative to other data strings in an ordered succession of data strings Cⱼ (j=1, . . . , n), and such that vᵢ is an integer depending on i and indicative of the value TVᵢ of Tᵢ, and is given by vᵢ=TVᵢ/(UV). The protocol may include the second party associating with Cᵢ an item Vᵢ, such that Vᵢ is substantially unpredictable by the first party. The protocol may include the second party determining whether a property Pᵢ holds between Cᵢ and Vᵢ, and if so, the second party causing a third party to receive information Iᵢ enabling the third party to verify whether Vᵢ satisfies Pᵢ. The protocol may include the third party verifying whether Vᵢ satisfies Pᵢ; and only if Vᵢ satisfies Pᵢ: a fifth party determining the value of Sₘₐₓ such that max is an integer such that 1≦max<i≦n, and vₘₐₓ=TVₘₐₓ/(UV), and such that Sₘₐₓ represents the largest of any serial number Sₖ (1≦k<n) contained in Cₖ for which: Cₖ is received by the second party before receiving Cᵢ; and the third party has verified that Vₖ satisfies Pₖ; and the first party was debited by a non-zero amount Dₖ, and the fifth party causing a fourth party to receive a credit amount CR; and c) the fifth party causing the first party to be debited by a debit amount Dᵢ, where Dᵢ is given by: (Sᵢ+vᵢ−1−Sₘₐₓ)*UV.

The micropayment selection protocol may establish payment for a plurality of n transactions Tᵢ (i=1, . . . , n), each transaction Tᵢ having a value TVᵢ. The protocol may include a first party deriving from each Tᵢ a data string Cᵢ related to Tᵢ, and causing a second party to receive the data string Cᵢ; The protocol may include the second party uniquely associating groups of the data strings Cᵢ (i=1, . . . , n) into m lists L^{k}, where k=1, . . . , m; such that each list L^{k} includes data strings C^{k}₁, . . . , C^{k}lₖ, and such that Σ^{m}ₖ₌₁lₖ=n; the second party committing to L^{k}(k=1, . . . , m), by computing a commitment CM^{k} for each L^{k}, and causing a third party to receive CM^{k} (k=1, . . . , m); the third party, in response to receipt of CM^{k} (k=1, . . . , m), selecting one or more integer indices i₁, i₂, . . . iᵣ, and causing the second party to receive the indices i₁, i₂, . . . iᵣ, such that 1≦iᵣ≦m; in response to receipt of the indices i₁, i₂, . . . iᵣ, the second party de-committing CMⁱ¹, CMⁱ² . . . CM^{ir}, thereby revealing Lⁱ¹, . . . , L^{ir} to the third party; and a fifth party causing a fourth party to receive a credit amount CR, and causing the first party to be debited by a debit amount D.

The micropayment selection protocol may establish payment for a plurality of n transactions T₁, . . . , Tᵢ, . . . , Tₙ, each transaction Tᵢ having a value TVᵢ. The protocol may include, for each Tᵢ, a first party receiving from a second party a data string Cᵢ derived from Tᵢ. The protocol may include the first party uniquely associating groups of the data strings Cᵢ (i=1, . . . , n) into m lists L^{k}, where k=1, . . . , m, such that each list L^{k} includes data strings C^{k}₁, . . . , C^{k}lₖ, and such that Σ^{m}ₖ₌₁lₖ=n. The protocol may include the first party committing to L^{k} (k=1, . . . , m), by computing a commitment CM^{k} for each L^{k}, and causing a third party to receive CM^{k} (k=1, . . . , m), thereby enabling the third party to select one or more integer indices i₁, i₂, . . . iᵣ, such that 1≦iᵣ≦m; upon receipt of the indices i₁, i₂, . . . iᵣ, the first party de-committing CMⁱ¹, CMⁱ² . . . CM^{ir}, thereby revealing Lⁱ¹, . . . , L^{ir} to the third party and enabling the third party to cause a fourth party to receive a credit amount CR, and the second party to be debited by a debit amount D.

The micropayment selection protocol may establish payment for a plurality of n transactions T₁, . . . Tᵢ, . . . , Tₙ, such that each transaction Tᵢ has a value TVᵢ and can be represented by a corresponding data string Cᵢ derived from Tᵢ, and such that groups of the data strings Cᵢ (i=1, . . . , n) can be uniquely associated into m lists L^{k} (k=1, . . . , m), each list L^{k} includes data strings C^{k}₁, . . . , C^{k}lₖ (Σ^{m}ₖ₌₁lₖ=n). The protocol may include a first party receiving from a second party a commitment CM^{k} for each of the m lists Lₖ (k=1, . . . , m). The protocol may include the first party, upon receiving CM^{k} (k=1. . . , m), selecting one or more integer indices i₁, i₂, . . . iᵣ, such that 1≦iᵣ≦m, and causing the second party to receive the indices i₁, i₂, . . . iᵣ, thereby enabling the second party to de-commit CMⁱ¹; CMⁱ² . . . CM^{ir} so as to revealing Lⁱ¹, . . . , L^{ir} to the first party. The protocol may include the first party causing a third party to receive a credit amount CR, and a fourth party to be debited by a debit amount D.

The above-described methods may also be implemented as a sequence of instructions executed by a processor.

The details of one or more implementations is set forth in the accompanying drawings and the description below. Other features and advantages will become apparent from the description, the drawings, and the claims.

### BRIEF DESCRIPTION OF THE DRAWINGS

FIG. 1 is a diagrammatic view of micropayment processing system coupled to a distributed computing network;

FIG. 2 is a more-detailed diagrammatic view of the micropayment processing system of FIG. 1;

FIG. 3 is a block diagram of an offer development module of the micropayment processing system of FIG. 1;

FIG. 4 is a block diagram of a consumer agent module of the micropayment processing system of FIG. 1;

FIG. 5 is a diagrammatic view of display screen rendered by the micropayment processing system of FIG. 1;

FIG. 6 is a block diagram of a PCS module of the micropayment processing system of FIG. 1;

FIG. 7 is a block diagram of a mPSP module of the micropayment processing system of FIG. 1;

FIG. 8 is a block diagram of a cPSP module of the micropayment processing system of FIG. 1;

FIG. 9 is a block diagram of a batch processing module of the micropayment processing system of FIG. 1;

FIG. 10 is a diagrammatic view of an encoded batch file; and

FIG. 11 is a block diagram of a verification module of the micropayment processing system of FIG. 1;

### DETAILED DESCRIPTION OF THE PREFERRED EMBODIMENTS

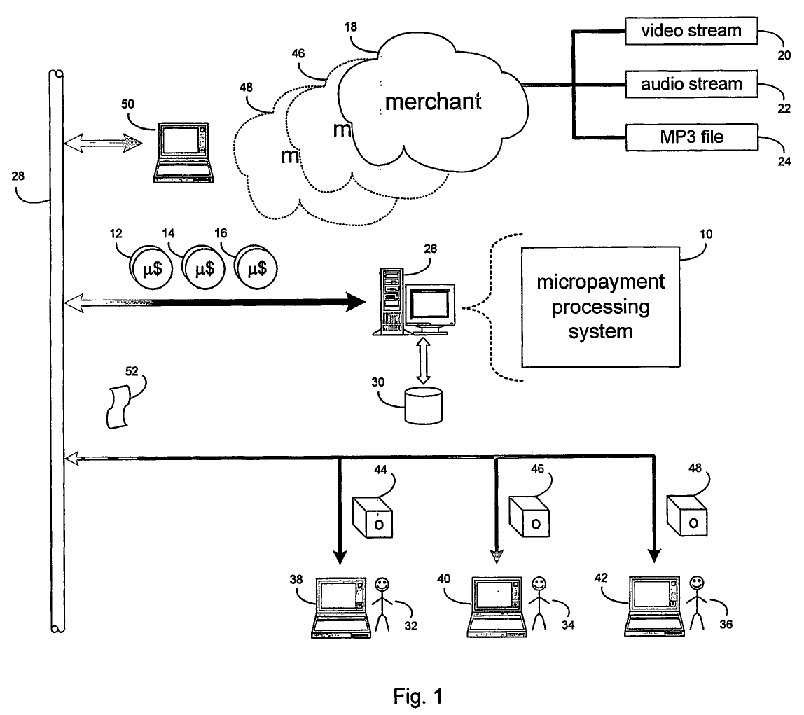

Referring to FIG. 1, there is shown a micropayment processing system 10 that processes various micropayments tokens (i.e., a token representative of low-value payments) 12, 14, 16 received by a merchant 18 for various products/services 20, 22, 24 offered by merchant 18.

Micropayment processing system 10 typically resides on and is executed by a computer 26 that is connected to network 28. Computer 26 may be a web server running a network operating system, such as Microsoft Window 2000 Server™, Novell Netware™, or Redhat Linux™. Typically, computer 26 also executes a web server application, such as Microsoft IIS™. Novell Webserver™, or Apache Webserver™, that allows for HTTP (i.e., HyperText Transfer Protocol) access to computer 26 via network 28.

The instruction sets and subroutines of micropayment processing system 10, which are typically stored on a storage device 30 coupled to computer 26, are executed by one or more processors (not shown) and one or more memory architectures (not shown) incorporated into computer 26. Storage device 30 may be, for example, a hard disk drive, a tape drive, an optical drive, a RAID array, a random access memory (RAM), or a read-only memory (ROM).

As will be discussed below in greater detail, one or more consumers 32, 34, 36 access and use various portions of micropayment processing system 10 (via consumer computers 38, 40, 42, respectively) to receive and review offer packages 44, 46, 48 concerning products/services 20, 22, 24 offered for sale by merchant 18, who accesses micropayment processing system 10 via merchant computer 50.

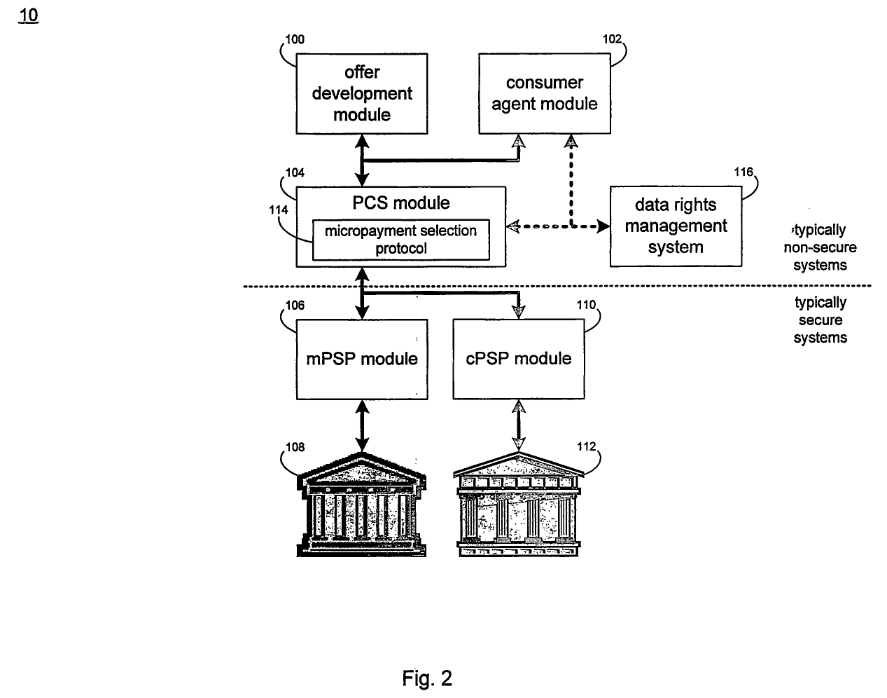

Referring also to FIG. 2, micropayment processing system 10 includes: an offer development module 100, a consumer agent module 102, a payment collection service (PCS) module 104, a merchant payment service provider (mPSP) module 106 (which interfaces with a merchant banking institution 108); and a consumer payment service provider (cPSP) module 110 (which interfaces with a consumer banking institution 112), each of which will be discussed below in greater detail.

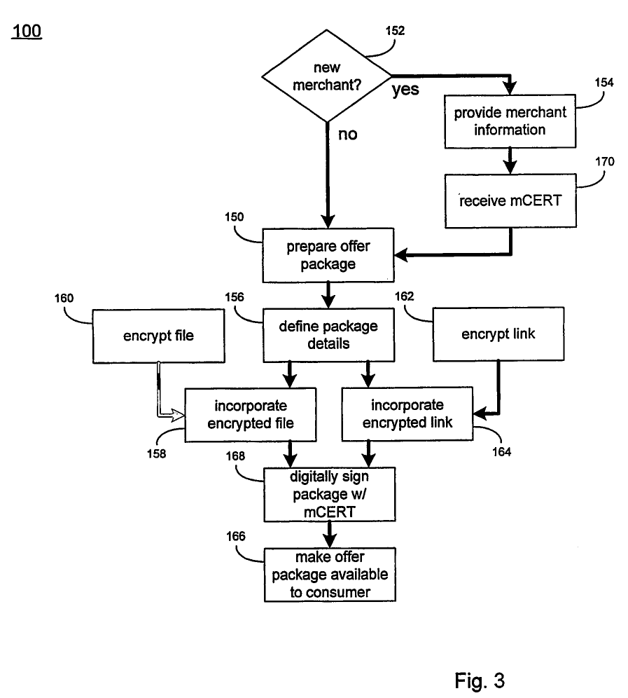

Referring also to FIG. 3, offer development module 100 allows merchant 18 to prepare 150 offer packages (e.g., offer packages 44, 46, 48) for distribution and solicitation to potential consumers.

When using offer development module 100, new merchants are required 152 to establish a merchant account prior to being able to prepare offer packages. Specifically, offer development module 100 allows a new merchant to access mPSP module 106 (to be discussed below in greater detail) and establish such a new merchant account.

When establishing a new merchant account, the new merchant provides 154 mPSP module 106 with information, such as: merchant name; merchant address; merchant username; merchant password; merchant email address; merchant telephone number; and merchant banking institution 108 (i.e., for defining the account(s) into which received funds are to be deposited).

As stated above, offer packages 44, 46, 48 pertain to various products/services that are offered for sale by merchant 18. Examples of these products/services may include an individual song encoded in a easily-transmittable format (such as an MP3 format), a streaming video broadcast of a concert, a streaming audio broadcast of a sporting event, and participation in an online video game for a defined period of time, for example.

The merchant uses offer development module 100 to define 156 an offer package for solicitation, such that the offer package typically includes a description of what is being offered (e.g., the latest release of song “X” by artist “Y”), and the cost of the offer package (e.g., $0.10). Additionally, the duration of what the consumer is offered is also defined. For example, the merchant may offer the product/service: (a) for an unlimited number of uses over an unlimited period of time, (b) for an unlimited number of uses over a limited period of time, (c) for a limited number of uses over an unlimited period of time, or (d) for a limited number of uses over a limited period of time, each of which impacts the cost of the product/service.

The offer package typically also defines: the merchant that is making the offer; the address or URL (i.e., uniform resource locator) of the PCS module 104 that will be processing the micropayment token; and the currency of the offer (e.g., U.S. dollars, European Euros, Japanese Yen, or British Pounds, for example). An expiration date concerning the offer (if applicable) may be included in the offer package for time sensitive events, such as those concerning promotional periods or the live broadcast of public events.

An encrypted copy of the product/service offered for purchase may be included 158 in the offer package (e.g., offer packages 44, 46, 48). For example, if the offer package concerns an individual song, the offer package prepared by the merchant may include the actual song offered for purchase. However, as will be discussed below in greater detail, the song is encrypted 160 prior to incorporation so that the consumer does not have access until the consumer accepts the offer and pays the merchant for the song. This type of offer is beneficial for product-based offers (e.g., an offer to purchase a song), as the offer cannot be accepted until after the offer package is downloaded. And, once the offer package is successfully downloaded, the offered product (i.e., the song) is already on the computer operated by the consumer. This, in turn, reduces the likelihood of a consumer claiming that they purchased a product that they were not able to retrieve (i.e., download).

Alternatively, an URL that provides a link to a website from which the product/service can be obtained may be encrypted 162 and included 164 in the offer package. Since this URL is encrypted, the URL is not useable until after the consumer accepts the offer and the merchant is paid for the product/service. This type of offer is beneficial for events that will occur in the future and for products not currently available (e.g., a streaming broadcast of the Superbowl™, and a song from an album that has not yet been released, for example).

Once merchant 18 defines an offer package, prior to offering 166 the offer package to the consumer, the offer package is digitally signed 168 by the merchant using a merchant digital certificate (hereinafter mCERT), which is typically received 170 from the mPSP module 106 (to be discussed below in greater detail) and authenticates the integrity of the offer package. The mCERT may be stored locally or retrieved from a remote computer (e.g., computer 26).

The mCERT is a file that establishes the credentials of the merchant. The mCERT typically contains the merchant's name, a unique merchant serial number (for identification purposes), a certificate expiration date, a copy of the merchant's public key (for encrypting messages and digital signatures), and the digital signature of the certificate-issuing authority (e.g., www.verisign.com™, or a third-party trust agent) so that a consumer can verify the integrity of the merchant digital certificate.

Typically, when using an mCERT, prior to making the offer package available to the consumer, a hashing algorithm generates a hash of the offer package, wherein the hash is essentially a mathematical summary of the offer package. The merchant then encrypts this hash using the private key of the merchant's private-public encryption key pair. This encrypted hash functions as the merchant's digital signature. When the consumer is verifying the integrity of the offer package, the consumer makes a hash of the offer package using the same hashing algorithm that the merchant used to make their hash. The consumer then uses the merchant's publicly-available public key to decrypt the digital signature (i.e., the hash made by the merchant) and the two hashes are compared. If the two hashes match, the integrity and authenticity of the offer package is confirmed.

Typically, a merchant (e.g., merchant 18) will simultaneously present to the potential customer multiple offer packages. For example, if the merchant is a music distribution website, the consumer may execute searches based on song title, album title, artist name, release date, or music type, for example. This, in turn, generates a results list that includes a URL to each of the results (i.e., offer packages) included in the results list. These offer packages may concern individual songs, compilations of songs, entire albums, or entire musical anthologies.

Offer development module 100 is typically a web-enabled application that is accessed by the merchant (e.g., merchant 18) through a browser application (e.g., Microsoft Internet Explorer™, or Netscape Navigator™) that is running on merchant computer 50, and the merchant logs into micropayment processing system 10 using an encrypted SSL (i.e., secure sockets layer) connection. Alternatively, offer development module 100 may be a local application that is executed locally on merchant computer 50.

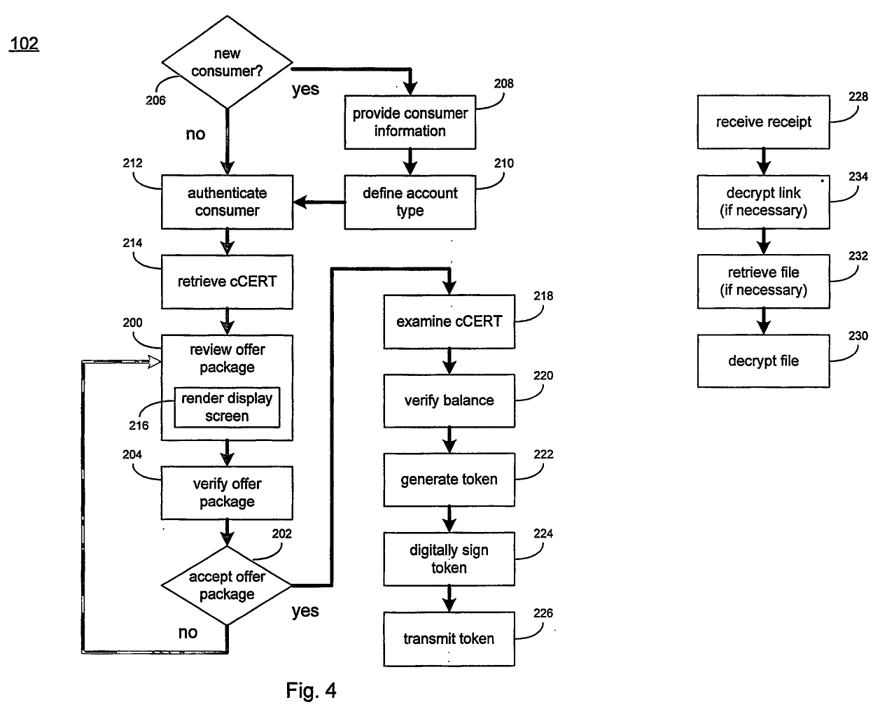

Referring also to FIG. 4, consumer agent module 102 allows the consumer to review 200 offer packages (e.g., offer packages 44, 46, 48) generated by merchant 18, and accept (i.e., purchase the product/service) 202 those offer packages in which the consumer is interested. Additionally, consumer agent module 102 verifies 204 the integrity of the offer package received from the merchant by making a hash of the offer package using the same hashing algorithm that the merchant used to make their hash of the offer package. The consumer agent module 102 then uses the merchant's publicly-available public key to decrypt the hash made by the merchant, and the decrypted merchant's hash and the consumer's hash are compared. If these two hashes match, the integrity and authenticity of the offer package is confirmed.

Typically, consumer agent module 102 is a web-enabled application that is accessed by the consumer (e.g., consumer 32) through a browser application that is running on a consumer computer (e.g., consumer computer 38), and the consumer securely logs into micropayment processing system 10 using an encrypted SSL connection. Alternatively, consumer agent module 102 may be a local application that is executed locally on a consumer computer 38.

When using consumer agent module 102, new users are required 206 to establish a consumer account prior to being able to accept offers and purchase the products/services being offered for sale by the merchant. Through the use of consumer agent module 102, a consumer can access cPSP module 110 (to be discussed below in greater detail) to establish such a new consumer account.

When establishing a consumer account, the new consumer provides 208 cPSP module 110 with information, such as: consumer name; consumer billing address; consumer username; consumer password; consumer email address; consumer telephone number; consumer credit card information (for billing purposes, thus defining the consumer banking institution 112 against which charges should be applied); and consumer age (for content regulation and access purposes), for example. Additionally, the consumer may define 210 the type of account, such as “prepay” or postpay”.

For prepay accounts, the consumer uses, for example, a credit card to transfer funds into the consumer account, and when using the account, the consumer is only permitted to purchase products/services if the balance in their consumer account is sufficient to cover the cost of the products/services sought. In the event that the account has insufficient funds to cover the purchase, the purchase is denied. This type of account is beneficial when, e.g., a parent wishes to control the spending of their teenage child.

Alternatively, the consumer account may be configured as a “postpay” account and, therefore, no prerequisite funds are required prior to allowing the consumer to make the purchase. However, a “credit limit” may be defined for a “postpay” account, such that the consumer can only purchase products/services up to a certain amount, above which the charges will be denied.

Once a consumer establishes a consumer account using consumer agent module 102, the consumer may accept 202 offers and, therefore, purchase products/services offered by the merchant.

As consumer agent module 102 allows a consumer to purchase the products/services offered for sale by the merchant, when using consumer agent module 102, the consumer is required to authenticate 212 their identity. This authentication may be accomplished by having the consumer enter their username and password combination, or through any other known means of identity authentication (e.g., token, certificate, or cookie passing).

Once the consumer's identity is authenticated, a consumer digital certificate (hereinafter cCERT) concerning the consumer using the consumer agent module 102 is retrieved 214 from cPSP module 110. Similar in nature to the mCERT, the cCERT typically contains the consumer's name, a unique consumer serial number (for identification purposes), a certificate expiration date, a copy of the consumer's public key (used for encrypting messages and digital signatures), and the digital signature of the certificate-issuing authority so that a merchant can verify the integrity of the consumer digital certificate. Typically, the unique consumer serial number allows for determination of the cumulative spending amount (to be discussed below) of the consumer to which the digital certificate pertains. Additionally, the cCERT may also define the status of the consumer's account (e.g., active, suspended or revoked, for example), and the type of consumer account (e.g., “prepay” or “postpay” account, for example).

When a consumer is reviewing 200 an offer through the browser application, the consumer agent module 102 is typically automatically launched in response to a consumer selecting an offer package for review, thus allowing the consumer to review the details of the offer package. This selection of an offer package for review is typically accomplished by the consumer “clicking” on the offer package or a link pointing to the offer package.

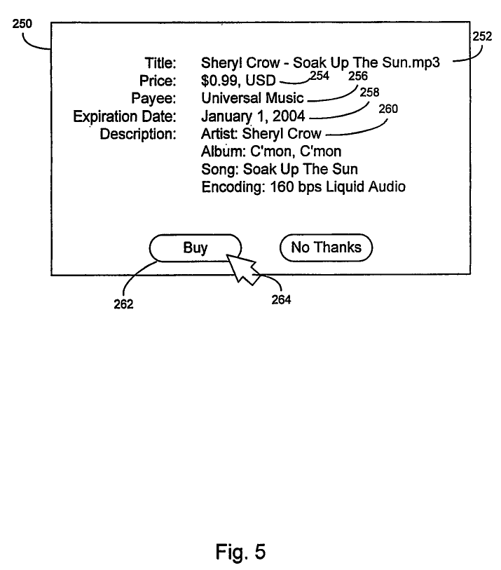

Referring also to FIG. 5, when reviewing 200 an offer package, consumer agent module 102 renders 216 a user interface display screen 250 that displays the details of the offer to the consumer, such as the artist and song title 252, the cost of the offer 254, the payee 256, the expiration date 258, and an overall description 260.

If, upon reviewing 200 an offer package, the consumer decides to accept 202 the offer and purchase the product/service offered by the merchant, the consumer executes an affirmative action to initiate the purchase, such as “clicking” on the buy button 262 with a mouse pointer 264 (or some other pointing device, not shown).

When the purchase is initiated, consumer agent module 102 examines 218 the cCERT to confirm that the consumer is not suspended. Further, if the consumer account is a prepay account, the consumer agent module verifies 220 that the balance in the consumer account is sufficient to cover the cost of the product/service sought.

Accordingly, if the consumer is an active (i.e., non-suspended) consumer and the account is either a postpay account or a sufficiently-funded prepay account, a micropayment token (e.g., token 12, 14, 16) is generated 222 for effectuating the purchase of the products/services offered by the merchant. The micropayment token is digitally signed 224 using the consumer's digital signature included in the cCERT retrieved by the consumer agent module 52. The micropayment token, which is transmitted 226 to PCS module 104, defines the product/service being purchased, defines the micropayment token amount (i.e., the amount of the purchase), identifies the consumer making the purchase, and defines the cumulative spend amount of that particular consumer. This cumulative spend amount, which is typically retrieved from the cPSP module 110 using the consumer serial number included within the cCERT, defines the total amount of monies previously spent by that consumer on products/services, and does not include the cost associated with the offer currently being accepted.

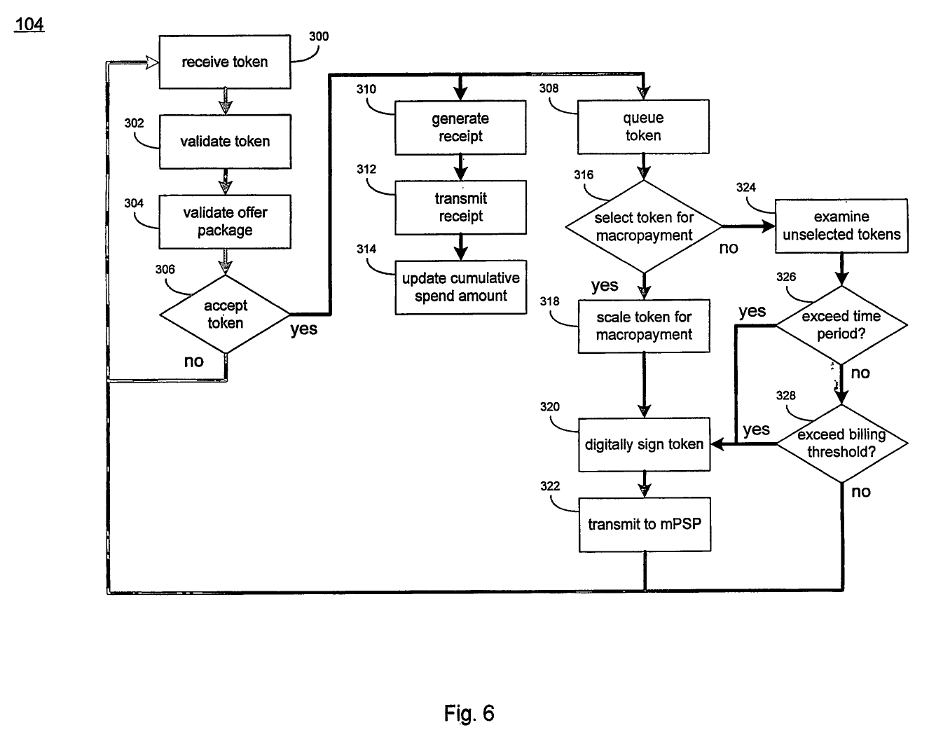

Referring also to FIG. 6, when the PCS module 104 receives 300 a micropayment token, the micropayment token is typically validated 302 to make sure that it is authentic and has not been tampered with. As stated above, the micropayment token transmitted by the consumer agent module 102 is digitally signed 224 using the digital signature of the cCERT. Therefore, a hash is made of the micropayment token and the hash is encrypted using the private encryption key of the consumer's private/public encryption key pair.

Accordingly, when validating the micropayment token, PCS module 104 makes a hash of the micropayment token using the same hashing algorithm that the consumer used to make their hash. The PCS module 104 then uses the consumer's public encryption key to decrypt the hash made by the consumer agent module and the two hashes are compared. If the two hashes match, the integrity and authenticity of the micropayment token is confirmed.

The token validation process 302 exercised by PCS module 104 typically also includes verifying that the cumulative spend amount specified in the micropayment token matches the cumulative spend amount specified in the cCERT.

PCS module 104 may also validate 304 the offer package (through the use of the merchant's digital signature and public encryption key include in the mCERT) to ensure the integrity of the offer package. This offer validation process 304 typically also includes: verifying that the offer package is still valid (e.g., was not withdrawn by the merchant, or did not expire, for example); and examining the offer package requirements to verify that the consumer meets any such requirements. For example, a 15 year old consumer would not be allowed to accept an offer package concerning the viewing of an NC-17 rated movie.

Once validated 302, 304, the micropayment token is accepted 306 by PCS module 104 and queued 308 for processing. Additionally, PCS module 104 generates 310 a content receipt 52 that is transmitted 312 to the consumer agent module 102 and typically includes a decryption key that allows the consumer to access the products/services purchased. Further, PCS module 104 also updates 314 (i.e., increments) the differential amount (to be discussed below) of the consumer's cumulative spend amount by the micropayment token amount.

As stated above, an offer package generated by the merchant may include an encrypted version of the actual data file (e.g., an MP3-based song file). If the consumer accepts such an offer, the data file purchased is already resident on the consumer's computer (e.g., computer 38). In this scenario, the receipt 228 of the content receipt 52 may trigger the consumer agent module 102 to decrypt 230 the data file resident on the consumer computer using the decryption key included in content receipt 52.

Alternatively and as discussed above, the offer package prepared by the merchant may only include a link to an encrypted data file which is resident on a remote computer (e.g., computer 26). In this scenario, the receipt 228 of the content receipt 52 (which includes a decryption key) may trigger the retrieval 232 of the encrypted data file (from the remote computer) prior to the decryption 230 of the encrypted data file.

Additionally and as discussed above, the offer package prepared by the merchant may only include an encrypted link to an encrypted data file which is resident on a remote computer (e.g., computer 26). In this scenario, the receipt 228 of the content receipt 52 may trigger the decryption 234 of the encrypted link, prior to the retrieval 232 and decryption 230 of the encrypted data file.

Further and as stated above, the consumer may be purchasing access to an audio, video, or audio/video stream for an event that is happening in the future. In this scenario, the decryption key included in the content receipt may be time-stamped and, therefore, not allow the consumer to access the stream until a time proximate the event. Additionally, the content receipt and/or the decryption key included in the content receipt may only be valid for a defined period of time. For example, the consumer may purchase one hour of access to an online gaming website. In such a scenario, the decryption key and/or content receipt may only be valid for a chronological hour or, alternatively, one hour of online time.

PCS module 104 executes the micropayment selection protocol 114, which is the subject of U.S. patent application Ser. No. 10/476,128, filed 27 Oct. 2003, entitled “method and System for Micropayment Transactions”, which claims the benefit of priority to International Application No.: PCT/US02/12189 (filed 17 Apr. 2002), which claims the benefit of priority to U.S. Provisional Application 60/287,251 (filed 27 Apr. 2001), U.S. Provisional Application 60/306,257 (filed 18 Jul. 2001), and U.S. Provisional Application 60/344,205 (filed 26 Dec. 2001), which is herein incorporated by reference. A copy of International Application No.: PCT/US02/12189 is attached hereto as Appendix A.

As thoroughly disclosed in U.S. patent application Ser. No. 10/476,128, micropayment selection protocol 114 processes micropayment tokens in a probabilistic fashion that is secure, random, and non-controllable by the consumer, merchant, or PSP module. Specifically, a defined percentage of micropayment tokens are selected 316 for processing, and the value of the micropayment token is increased (i.e., scaled by the inverse of the defined percentage) 318 so that a macropayment can be made to merchant 18. For example, assume that the defined percentage is 1% (i.e., 1 in 100) and, therefore, one out of every one hundred micropayment tokens is selected for processing. Accordingly, a macropayment is made to the merchant that is scaled upward in accordance with the selection ratio. Therefore, if the value of the selected micropayment token is $0.99 and the selection ratio is one in one hundred, the value of the macropayment made to the merchant is $99.90 (i.e., one hundred times the actual value of the micropayment token).

Concerning the non-selected micropayment tokens (i.e., ninety-nine out of one hundred in this example), merchant 18 never receives payment for these micropayment tokens, as the single macropayment represents the probabilistic equivalent of the sum of these ninety-nine, non-selected micropayment tokens and the one selected micropayment token.

When a micropayment token is selected for processing by micropayment selection protocol 114 and is used as the basis for paying a macropayment to merchant 18, as stated above, the value of the micropayment token is increased 318 to the appropriate macropayment level. The micropayment token is then digitally signed 320 by PCS module 104 and then transmitted 322 to mPSP module 106 for processing.

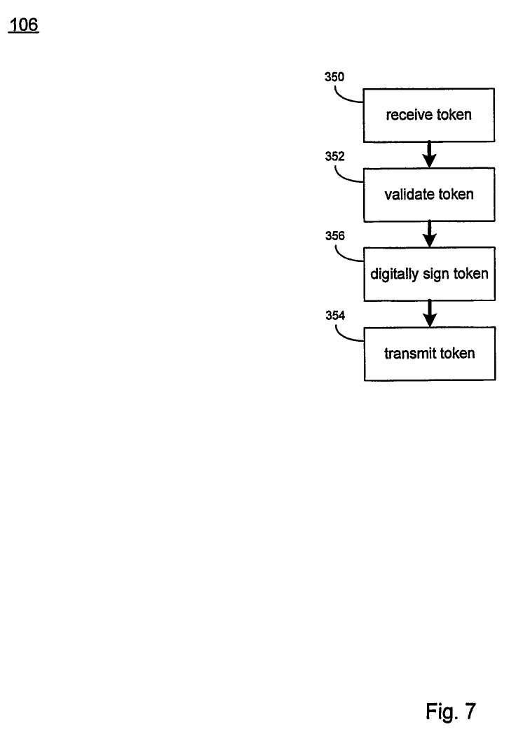

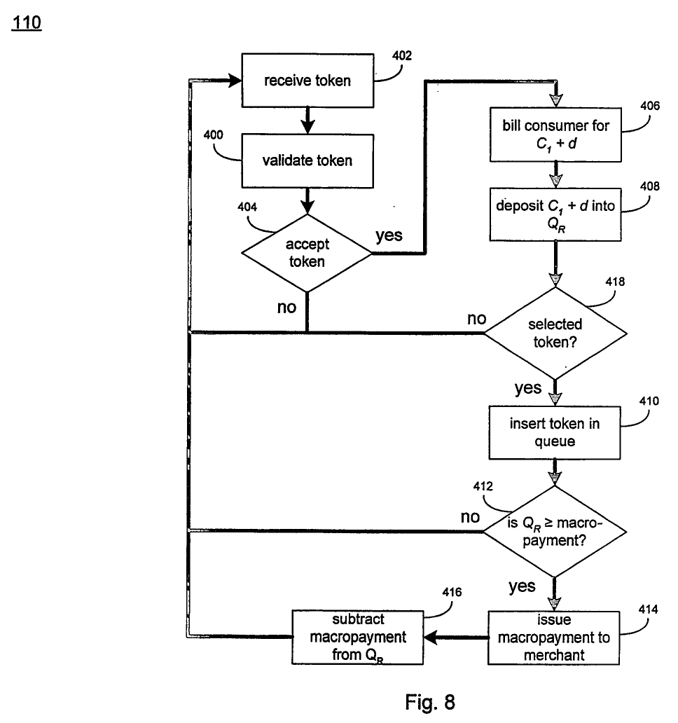

Referring also to FIGS. 7 and 8, mPSP module 106 is a payment service provider that is acting on behalf of merchant 18. When mPSP module 106 receives 350 the micropayment token from PCS module 104, the validity of the micropayment token is verified 352.

As disclosed above, the micropayment token is typically digitally signed 320 by PCS module 104 prior to being transmitted 322 to the mPSP module 106. Accordingly, when the micropayment token is received 350 by mPSP module 106, mPSP module 106 validates 352 the micropayment token by generating a hash of the micropayment token, decrypting the encrypted hash generated by the PCS module 104, and comparing the two hashes. If there is a match, the validity of the micropayment token is verified.

Once the micropayment token is validated 352 by the mPSP module, the micropayment token is transmitted 354 to cPSP module 110 for further processing. As mPSP module 106 is acting on behalf of merchant 18 and cPSP module 110 is acting on behalf of the consumer, mPSP module 106 will typically digitally sign 356 the micropayment token prior to transmission 354. The cPSP module 110 will typically verify 400 the validity of the micropayment token upon receipt 402 (using the above-described procedures) and prior to acceptance 404. Once validated 400 and accepted 404, the micropayment token is queued (to be discussed below) for processing by cPSP module 110.

The queuing of micropayment tokens reduces the risk of system illiquidity and merchant/consumer collusion. As disclosed above, each selected micropayment token (i.e., a token selected for macropayment processing) that is processed by cPSP module 110 specifies the cost of the offer d (i.e., the micropayment token amount), a stepped-up macropayment amount D (i.e., the offer cost multiplied by a scaling factor), and a cumulative spend amount C_{J}+C_{I}

For example, assume that the consumer repeatedly makes purchases that have a micropayment token amount d of $0.10. Further, as micropayment selection protocol 114 processes micropayment tokens in a probabilistic fashion in accordance with a defined percentage or ratio, assume that the first seventy-five times that the consumer made this purchase, the consumer's micropayment token was not selected and, therefore, the consumer was never billed for their purchases. Accordingly, when the consumer makes their seventy-sixth purchase, the cumulative spend amount C_{J}+C_{I} specified in the micropayment token is $7.50, such that C_{J} (i.e., the last amount previously billed to the consumer) is equal to $0.00 (as the consumer has never been billed for any of their previous seventy-five purchases) and C_{I} (i.e., the differential amount that the consumer has spent since the last billing) is equal to $7.50, which represents the cost of the previous seventy-five unbilled purchases.

Queues maintained by cPSP module 110 consists of a queue reserve Q_{R} and an ordered set of pending (i.e., yet-to-be-processed) micropayment tokens (e.g., tokens 12, 14, 16). As cPSP module 110 receives 402, validates 400, and accepts 404 the micropayment tokens, cPSP module 110 bills 406 the consumer banking institution 112 for the differential amount spent (C_{I}) plus the micropayment token amount d. Since, in this particular example, the consumer has never been billed, this differential amount is $7.50 and the micropayment token amount is $0.10. Therefore, cPSP module 110 bills 406 consumer banking institution 112 for $7.60, which is deposited 408 into queue reserve Q_{R}.

The cPSP module 110 then inserts 410 the selected micropayment token into the back of the queue, which is typically a first-in-first-out (FIFO) queue. A FIFO queue is a queue in which the oldest entry is serviced first and, conversely, the newest entry is serviced last. The cPSP module 110 repeatedly compares 412 the macropayment amount D of the stepped-up micropayment token that is next in line for processing (i.e., the token that is at the front of the queue) to the current balance of the queue reserve Q_{R}. Only when the current balance of the queue reserve Q_{R} (which is currently at $7.60) is greater than or equal to the macropayment amount D of the micropayment token being examined (which in this example is $10.00) will the stepped-up micropayment token be processed and the macropayment paid to the merchant.

As queue reserve Q_{R} is currently less than the macropayment amount D, the macropayment will not be made to the merchant. However, as the differential value of each subsequently-received micropayment token (that is validated by cPSP module 110) is deposited into the queue reserve Q_{R}, eventually the value of queue reserve Q_{R} will be greater than or equal to the value of the macropayment amount D. When this occurs, the macropayment is issued 414 to the merchant banking institution 108 (via mPSP module 106) and the value of the macropayment is deducted 416 from queue reserve Q_{R}.

This process is repeated for each micropayment token that is at the front of the queue until either: (a) the queue is empty, or (b) there are inadequate reserves to settle the micropayment token at the front of the queue.

Concerning the queue(s) maintained by cPSP module 110, the queue(s) may be configured such that (a) all consumers use a common queue, (b) each consumer has their own separate queue, or (c) defined groups of consumers share a queue common for that defined group.

As discussed above, micropayment selection protocol 114 processes micropayment tokens in a probabilistic fashion in accordance with a defined percentage or ratio. In the example above, this ratio is one in one-hundred, in that one out of every one-hundred micropayment tokens received by the PCS module 104 is selected for processing so that cPSP module 110 may bill the consumer for the actual amount of the purchase and mPSP module 106 may make a macropayment to the merchant via merchant banking institution 108.

However, the unselected micropayment tokens still must be processed and the consumers billed in order to recover the differential cost between the amount of the macropayment made to the merchant and the micropayment token amount d collected from the consumer. Accordingly, PCS module 104 repeatedly examines the unselected micropayment tokens to determine if any of them may be sent to mPSP 106 and cPSP 110 for processing.

Specifically, the PCS module 104 examines 324 each unselected micropayment token to make two determinations: (a) the actual time period since the unselected token was generated; and (b) and the differential amount C_{I} that the consumer has spent since the last time that the consumer was billed. If 326 the actual time period since the micropayment token was generated exceeds a predetermined time period (e.g., thirty days), the micropayment token is digitally signed 320 and transmitted 322 to mPSP module 106 for processing. Further, if 328 the differential amount C_{I} exceeds a predefined minimum billing threshold (e.g., $5.00), the micropayment token is digitally signed 320 and transmitted 322 to mPSP module 106 for processing.

When received 350 by mPSP module 106, the unselected micropayment tokens are processed similarly to that of the selected micropayment tokens (i.e., they are validated 352 and verified 354). However, since the unselected micropayment tokens are not stepped-up in value to reflect a macropayment amount, no payment is made to the merchant concerning these unselected micropayment tokens, as the stepped-up macropayments made to the merchant already paid the merchant for any non-selected micropayment tokens.

Accordingly, when mPSP module 106 receives a non-selected micropayment token for processing, the non-selected micropayment token is transmitted 354 to cPSP module 110 for consumer billing purposes.

Each unselected micropayment token specifies the micropayment token amount d, and a cumulative spend amount C_{J}+C_{I}, such that C_{J} represents the last amount previously billed to the consumer and C_{I} represents the differential amount that the consumer has spent since the last billing. The cPSP module 110 bills 406 the consumer (via the consumer banking institution 112) for the differential amount spent (C_{I}) plus the micropayment token amount d. These received funds are then deposited 408 into the queue reserve Q_{R}, thus raising the value of the queue reserve Q_{R} and allowing for the payment of additional macropayments to the merchant(s). However, since 418 these are unselected micropayment tokens, these unselected tokens are not placed into the queue to await macropayment, as macropayments are not made on unselected tokens.

Concerning the cumulative spend amount, this value is maintained (on storage device 30) by PCS module 104. As stated above, the cCERT retrieved by consumer agent module 102 specifies a serial number that allows the consumer agent module 102 to retrieve (from PCS module 104) the current cumulative spend amount, which is incorporated into any micropayment tokens (e.g., tokens 12, 14, 16) generated by the consumer agent module 102. Accordingly, by ensuring the accuracy of the cumulative spend amount maintained on PCS module 104, the accuracy of the cumulative spend amount specified in the micropayment tokens is also ensured.

As stated above, the cumulative spend amount is defined as C_{J}+C_{I}, such that C_{J} represents the last amount previously billed to the consumer, and C_{I} represents the differential amount that the consumer has spent since the last billing. Accordingly, whenever a micropayment token is processed, regardless of whether it is an unselected token or a token that was selected by micropayment selection protocol 114 as a basis for a macropayment, the consumer is billed 406 for the differential amount spent (C_{I}) plus the micropayment token amount (d). Therefore, each time a micropayment token is processed (i.e., transmitted to mPSP module 106), the cumulative spend amount maintained by PCS module 104 is updated 314. When updating the cumulative spend amount, C_{J} is set equal to the sum of (C_{J}), (C_{I}), and (d), and the differential amount spent (C_{I}) is reset to zero (as the client is currently being billed and, therefore, has not purchased anything since their last billing).

Continuing with the above stated example, when the consumer made their seventy-sixth purchase, their micropayment token was selected by micropayment selection protocol 114. At this point in time, the cumulative spend amount C_{J}+C_{I} specified in the micropayment token and the PCS module 104 is $7.50, such that C_{J} (i.e., the last amount previously billed to the consumer) is equal to $0.00 (as the consumer has never been billed for any of their previous seventy-five purchases) and C_{I} (i.e., the differential amount that the consumer has spent since the last billing) is equal to $7.50, which represents the cost of the previous seventy-five unbilled purchases.

Accordingly, when updating the cumulative spend amount of this consumer, C_{J} is set equal to the sum of (C_{J}), (C_{I}), and (d), i.e., $0.00+$7.50+$0.10. Further, the differential amount spent (C_{I}) is reset to zero. Therefore, when the consumer generates a seventh-seventh micropayment token, the cumulative spend amount C_{J}+C_{I} retrieved from the PCS module 104 and incorporated into the seventy-seventh micropayment token will be $7.60, such that C_{J} is equal to $7.60 and C_{I} is equal to $0.00.

Micropayment processing system 10 may access a token processing fee for each micropayment token processed. Depending on how the system is configured, one or more of the following may apply: (a) the consumer may be charged for each token that consumer generates; (b) the merchant may be charged for each token used as a basis for a macropayment made to that merchant; or (c) the merchant may be charged for each token directed toward that merchant; for example.

Micropayment selection protocol 114, which is fully disclosed in and the subject of International Application No.: PCT/US02/12189 (attached hereto as Appendix A), is a secure selection protocol, in that the module(s) executing the protocol need not be operated on a secure system in order for the protocol to be secure. For example, while mPSP module 106 and cPSP module 110 are typically operated on a secure system, offer development module 100, consumer agent module 102, and PCS module 104 may be operated on non-secure systems, thus lowering the overall operating cost of micropayment processing system 10.

As described above, various modules within the micropayment processing system 10 hash and digitally sign data objects prior to transmission. Examples include: the offer development module 100 that hashes and digitally signs offer packages; the consumer agent module 102 that hashes and digitally signs micropayment tokens prior to sending them to the PCS module; the PCS module 104 that hashes and digitally signs micropayment tokens prior to sending them to the mPSP module; and the mPSP module 106 that hashes and digitally signs micropayment tokens prior to sending them to the cPSP module.

Unfortunately, digitally signing data objects' consumes considerable computational bandwidth, especially when compared to the computational bandwidth required to hash a data object. As will be discussed below in greater detail, by batch processing data objects, large reductions in computational bandwidth can be realized while incurring only a modest increase in processing lag time.

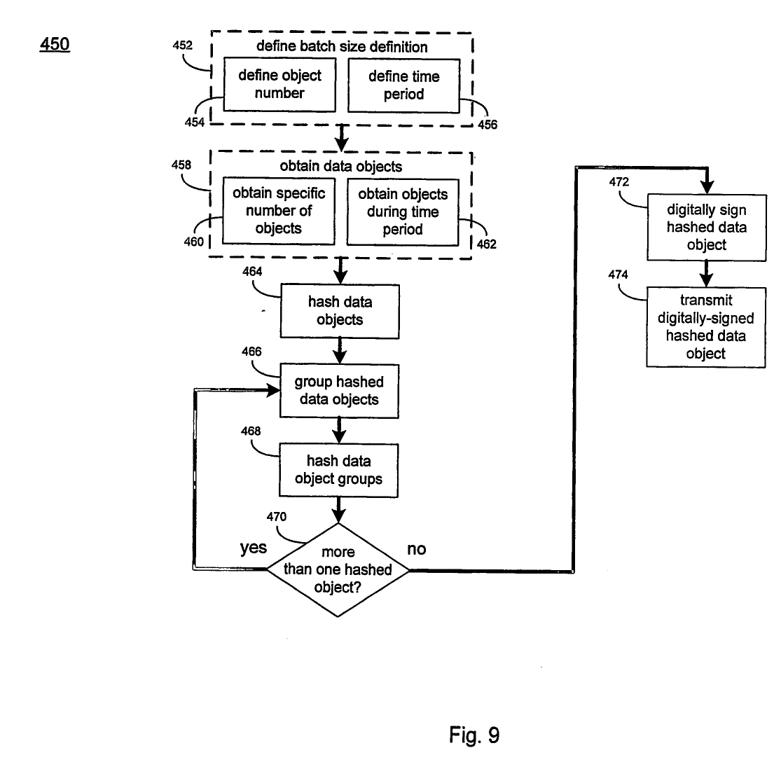

Referring also to FIG. 9, batch processing module 450 may be included in any of the modules (e.g., modules 100, 102, 104, 106 and/or 110) of the micropayment processing system 10. Batch processing module 450 allows for the batch processing of data objects (e.g., offer packages and micropayment tokens, for example).

As discussed above, each data object is typically hashed and then digitally signed. Therefore, for a batch of eight data objects, eight hashing operations and eight signing operations would traditionally be required. However, batch processing module 450 requires only one digital signing operation and 2N−1 hashing operations (i.e., 15 hashing operations) per batch of eight data objects processed. Assuming that it requires 10⁴ times the hash processing power to produce a single digital signature, the traditional one-signature-per-object process requires 80,008 processing units (i.e., 8 signatures @ 10,000 units each and 8 hashes @ 1 unit each) versus 10,015 processing units (i.e., 1 signature @ 10,000 units each and 2N−1 hashes @ 1 unit each). Accordingly, the use of batch processing module 450 results in a processing bandwidth reduction of 87.48%.

The processing bandwidth savings are even more substantial when the batch size is increased. For example, for a batch size of sixty-four, the traditional one-signature-per-object process requires 640,064 processing units (i.e., 64 signatures @ 10,000 units each and 64 hashes @ 1 unit each) versus 10,127 processing units (i.e., 1 signature @ 10,000 units each and 2N−1 hashes @ 1 unit each). Accordingly, for a batch size of sixty-four, the use of batch processing module 450 results in a processing bandwidth reduction of 98.41%.

However, this increased efficiency does not come without cost, as the larger the batch size, the longer amount of time required to build such a batch. For example, if system 10 is generating one data object per microsecond, a sixty-four object batch can be assembled in sixty-four microseconds (i.e., most likely an acceptable level of delay). However, if system 10 is generating one data object per second, it would take over one minute to assemble a sixty-four object batch (i.e., most-likely an unacceptable delay).

Accordingly, when defining the batch size, consideration should be given to the acceptable level of delay. Therefore, it may be desirable to define a batch as the number of objects acquired during a fixed period of time (e.g., 0.100 seconds), such that the 0.100 seconds represents the acceptable level of delay.

Batch processing module 450 allows a user to define 452 a batch size definition. When defining this batch size definition, the user may define 454 the number of data objects to be included within the batch. Alternatively, the user may define 456 a time period (e.g., 100 milliseconds), such that the number of data objects included in the batch is the number of data objects made available during the time period.

Regardless of the manner in which the batch size is defined (i.e., time period or data object number), batch encoding process 450 obtains 458 the data objects required to assemble the batch. If the user defined the batch size as a specific number of data objects, batch processing module 450 obtains 460 the specific number of data objects. If the user defined the batch size as the number of objects available during a specific time period, batch processing module obtains 462 the data objects made available during the specific time period.

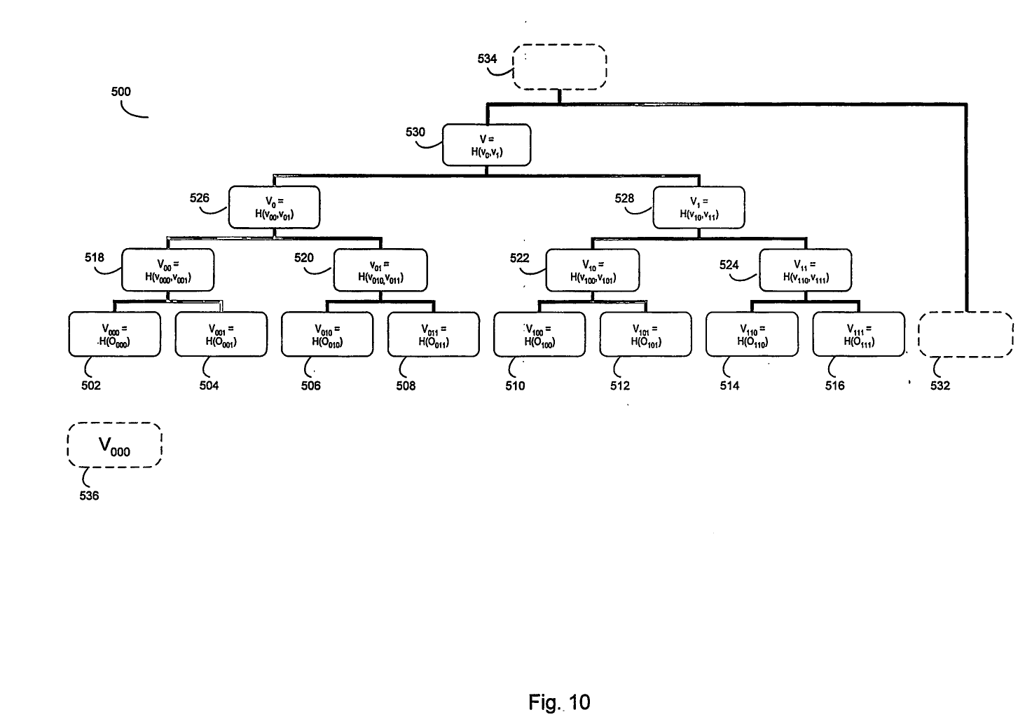

Referring also to FIG. 10, a graphical representation of an encoded batch file 500 is shown, which represents the end product of batch encoding process 450. In this particular example, batch file 500 includes eight data objects 502-516, each of which may represent a micropayment token or an offer package, for example.

When generating an encoded batch file (e.g., encoded batch file 500), batch encoding process 450 obtains 458 the appropriate number of data objects (e.g., data objects 502-516). Once these data objects are obtained, batch processing module 450 hashes 464 each data object to generate a hashed data object for each data object.

Once hashed 464, these hashed data objects are grouped 466 into pairs of hashed data objects (e.g., object pair 502/504, object pair 506/508, object pair 510/512, and object pair 514/516) and these pairs of hashed data objects are hashed 468, thus producing four hashed data objects 518, 520, 522, 524 (respectively), each of which corresponds to a single pair of hashed data objects. Batch encoding process 450 monitors 470 the number of hashed data objects generated when hashing 468 the pairs of hashed data objects, and this grouping 466 and hashing 468 is recursively repeated until there is only one hashed data object generated.

Continuing with the above-stated example, as four hashed data objects were generated, these four hashed data objects are grouped 466 into two pairs of hashed data objects (e.g., object pair 518/520, and object pair 522/524) and these two pairs of hashed data objects are hashed 468, thus producing two hashed data objects 526, 528 (respectively).

Since batch processing module 450 determines 470 that more than one hashed data object was generated, these two hashed data objects are grouped 466 into one pair of hashed data objects (e.g., object pair 526/528) and this pair of hashed data objects is hashed 468, thus producing one hashed data object 530.

Since batch processing module 450 determines 470 that only one hashed data object was generated, batch processing module 450 digitally signs (i.e., encrypts) 472 the hashed data object, and the digitally signed, hashed data object is transmitted 474 to the intended recipient. As will be explained below in greater detail, once this digitally signed, hashed data object is received by the intended recipient, any of the original eight data objects 502-516 maybe decoded.

In the above-stated example, the grouping 466 of the eight hashed data objects resulted in four pairs, which were hashed 468 and resulted in two pairs, which were hashed 468 and resulted in one pair, which was hashed 468, signed 472, and transmitted 474. Unfortunately, this grouping and hashing only works this smoothly when the initial number of data objects is a power of two (i.e., 2, 4, 8, 16, 32, 64, or 128, for example). However, if the user of batch processing module 450 defines 452 a batch size by defining 456 a time period, the number of data objects processed may be any number.

According, when processing hashed data objects, if the number of hashed data objects being paired is an odd number, those data objects that could be paired are paired and the single, non-pairable hashed data object is subsequently paired at a higher level. This subsequent pairing occurs when hashing process 468 generates an odd number of hashed data objects.

For example, assume that in addition to the eight data objects (i.e., data objects 502-516) processed in the above-stated example, a ninth data object 532 is also processed. The pairing of this ninth data 532 is delayed until an odd number of hashed data objects is generated. As stated above, the pairing of the eight data objects results in four pairs (i.e., object pair 502/504, object pair 506/508, object pair 510/512, object pair 514/516); which are hashed and grouped, resulting in two pairs (i.e., object pair 518/520, object pair 522/524); which are hashed and grouped, resulting in a single pair (i.e., object pair 526/528); which is hashed and results in a single hashed data object 530. As hashed data object 530 represents the first time that a single hashed data object is generated, the ninth data object 532 is hashed 464 and paired 466 with hashed data object 530, resulting in object pair 530/532. Object pair 530/532 is subsequently hashed 468, and new hashed data object 534 is generated.

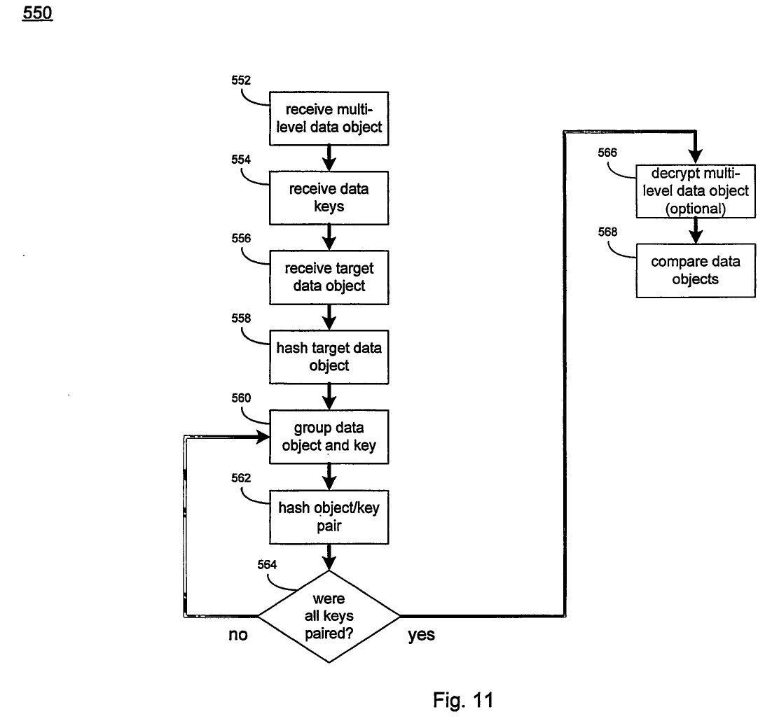

Referring also to FIG. 11, verification module 550 may be included in any of the modules (e.g., modules 100, 102, 104, 106 and/or 110) of the micropayment processing system 10. Verification module 550 allows for the verification of the digitally signed, hashed data objects (e.g., data object 530) generated by batch processing module 450.

Verification module 550 receives 552 the digitally signed, hashed, data object 530, which (as discussed above) is a multi-level data object that represent multiple levels of data within an encoded batch file 500. Data object 530 includes a hashed target data object (e.g., data object 502) and one or more hashed, non-target data objects (i.e., data objects 504-528).

Verification module 550 also receives 554 one or more sequential data keys (e.g., data objects 504, 520, 528), such that each of these sequential data keys corresponds to a hashed non-target data object at a unique level within the digitally-signed, hashed data object 530. Additionally, verification module 550 receives 556 a non-hashed target data object 536 (e.g., a non-hashed version of hashed target object 502).

Through the use of the data keys (e.g., data objects 504, 520, 528) and the non-hashed target data object 536, the validity of signed, hashed, data object 530 and target data object 502 (embedded within signed, hashed, data object 530) can be confirmed.

Continuing with the above-stated example, assume that hashed, multi-level data object 530 was digitally signed by batch processing module 450 and is received 552 by verification module 550. As discussed above, data object 530 is an hashed data object that includes the information from eight data objects, namely data objects 502-516. Assume that data object 502 is the hashed target data object (i.e., the offer package or token to be processed). Being the path between data object 530 and data object 502 splits three times, three data keys are required to map the path between these two data objects and, therefore, validate the integrity of the hashed target data object (i.e., data object 502) specifically and the hashed data object 530 generally.

Specifically, these three data keys correspond to the hashed values of the data objects on the non-selected paths of a data split. For example, when mapping from data object 530 to the target,data object 502, the first split encountered is the split between data object 526 and data object 528. As data object 526 is the selected path (i.e., data object 526 maps toward data object 502), data object 528 lies on the non selected path and, therefore, the hashed value of data object 528 is one of the three data keys required to validate data object 502. The other two data keys are data object 520 (i.e., for the second split) and data object 504 (i.e., for the third split).

Therefore, continuing with the above-stated example, verification module 550 receives 554 the three data keys required to validate target data object 502. As explained above, these data keys are hashed data objects 528, 520, and 504. Additionally, verification module 550 receives 556 the non-hashed, target data object 536.

Verification module 550 hashes 558 non-hashed, target data object 536 to generate a first level hashed data object (i.e., data object 502 within multi-level, data object 530). Module 550 groups 560 hashed data object 502 (i.e., the first level hashed data object) with the first level sequential data key (i.e., data object 504) to generate first level object/key pair 502/504, which is hashed 562 to generate a second level hashed data object (i.e., hashed data object 518). If 564 all of the sequential data keys were not paired with hashed data objects, the grouping process 560 and the hashing process 562 must be repeated until all sequential data keys are exhausted.

As there are two sequential data keys remaining (i.e., data keys 520, 528), verification module 550 groups 560 second level hashed data object 518 with the second level sequential data key (i.e., data object 520) to generate second level object/key pair 518/520, which is hashed 562 to generate a third level hashed data object (i.e., hashed data object 526).

As there is one sequential data key remaining (i.e., data key 528), verification module 550 groups 560 third level hashed data object 526 with the third level sequential data key (i.e., data object 528) to generate third level object/key pair 526/528, which is hashed 562 to generate a fourth level hashed data object (i.e., hashed data object 530).

As there are no sequential data keys remaining, the grouping process 560 and the hashing process 562 are complete. Optionally, module 550 decrypts 566 hashed, multi-level data object 530 to generate a decrypted, hashed multi-level data object (i.e., a decrypted version of hashed, multi-level data object 530). Module 550 then compares 568 this decrypted version of hashed, multi-level data object 530 to the fourth level hashed data object to see if they match. In the event that these two data objects match, the validity of the multi-level data object 530 and target data object 502 are confirmed.

While hashed data objects are described above as being grouped into pairs of hashed data objects, other configurations are possible in which larger numbers of hashed data objects are grouped together.

While the content receipt that is transmitted to the consumer agent module is described above as typically including a decryption key that allows the consumer to access the products/services purchased, other more complex configurations that utilizes a series of keys are possible.

For example, PCS module 104 may generate a PCS MCK encryption key pair, and the public key portion may be stored within the mCERT. The offer development module 100 may produce a symmetric master content key on a periodic process. The offer development module 100 would store the master content key, as well as a copy of the master content key encrypted by the public key of the PCS MCK encryption key pair. This master content key set (i.e., the encrypted and non-encrypted versions) may be used for any number of offer packages, as described below.

For example, for each offer package, the offer development module 100 may generate a symmetric content key, such that the content key is used to encrypt the offer package content file (e.g., the song, or URL, for example). The offer development module 100 then uses the master content key to encrypt the content key, such that the encrypted content key and the encrypted master content key are stored inside the offer package. The offer development module 100 then signs the entire offer package using the encryption key within the mCERT.

Once the PCS module 104 validates the micropayment token, the PCS module 104 decrypts the content key for the given micropayment token as follows. If the master content key for this micropayment token is not cached, decrypt the master content key using the PCS MCK encryption key and cache the master content key for future use. Otherwise, use the cached master content key to decrypt the content key using the decrypted, cached master content key. The resulting content key is then sent to the consumer agent module 102 with the content receipt.

While the micropayment processing system is shown to service only one merchant (i.e., merchant 18), other configurations are possible. For example, the micropayment processing system may be configured to process micropayment tokens directed to multiple merchants, such as merchants 46, 48. Additionally, the micropayment processing system may include multiple PCS modules configured to process micropayment tokens directed to a single larger merchant. Further, as the micropayment processing system is scalable, banks of PCS modules may be configured to distributedly process micropayment tokens directed to multiple merchants.

While modules 100, 102, 104, 106, and 110 are described above as being directly accessed, other configurations are possible that allow for access via proxies. For example, offer development module 100 may be accessed via a browser application (e.g., Microsoft Internet Explorer™, or Netscape Navigator™) that is running on merchant computer 50. Accordingly, the browser application would allow for the merchant to access offer development module 100 (which is operating remotely on a web server) and remotely configure offer packages that are reviewable by the consumer.

While a monetary cost is associated with each offer package described above, other configurations are possible. For example, the cost of an offer package may be specified in frequent flyer miles, in that a consumer uses their frequent flyer miles to purchase products/services. Alternatively, the cost of an offer package may be specified in consumer points, such that consumers earn points each time they purchase consumer products (e.g., soda, cereal, or potato chips, for example), and the points earned may be used to purchase products/services, for example.

While the above-described system discloses verifying age requirements at the time that a micropayment token is received for processing by the PCS module, other configurations are possible. For example, the system may be configured so that the consumer agent module only allows a consumer to review the details of an offer package if that consumer meets the age requirements.

While the above-described system discloses verifying account balances at the time that a micropayment token is generated by the consumer agent module, other configurations are possible. For example, the system may be configured so that the consumer agent module only allows a consumer to review the details of an offer package if that consumer has a sufficiently high account balance.

While micropayment selection protocol is described above as selecting a defined percentage of micropayment tokens for processing and increasing the value of the selected micropayment tokens by the inverse of this defined percentage, other configurations are possible, such as the merchant defining the desired size of the macropayment. For example, if a merchant wanted to receive macropayments of $100.00 and the value d of the micropayment tokens are $0.20 each, the scaling factor would be ^{$100.00}/_{$0.20} (i.e., 500) and, therefore, the selection ratio would be set so that one out of every five-hundred tokens is selected for processing.

While the micropayment system is described above as locally storing the data files offered for purchase by the merchant(s) using the system, other configurations are possible. For example, a third-party data rights management system 116 may be utilized that allows for the remote storage of data files. Additionally, data rights management system 116 may also control the access and downloading of the data files.

While the consumer is shown as accessing micropayment processing system exclusively through the use of a computer, other configurations are possible. For example, the consumer may access the micropayment system via a handheld device, such as a cellular telephone, or a personal digital assistant (e.g. a Palm™ or Pocket PC™ handheld device, not shown).

A number of implementations have been described. Nevertheless, it will be understood that various modifications may be made. Accordingly, other implementations are within the scope of the following claims.

1-150. (canceled)

151. A verification method comprising:
receiving a hashed, multi-level, data object, wherein the hashed, multi-level, data object includes one or more hashed, non-target data objects;
receiving one or more sequential data keys, wherein each sequential data key corresponds to a hashed, non-target data object at a unique level within the hashed, multi-level, data object;
receiving a non-hashed, target data object;
hashing the non-hashed, target data object to generate an N^{th} level hashed data object;
grouping the N^{th} level hashed data object with an N^{th} level, sequential data key to generate an N^{th} level object/key pair; and
hashing the N^{th} level object/key pair to generate an N^{th+1} level hashed data object;
wherein grouping the N^{th} level hashed data object and hashing the N^{th} level object/key pair are repeated for each sequential data key.

152. The method of claim 151 wherein the hashed, multi-level, data object is an encrypted, hashed, multi-level, data object, the method further comprising:
decrypting the encrypted, hashed, multi-level, data object to generate a decrypted, hashed, multi-level, data object.

153. The method of claim 152 further comprising:
comparing the decrypted, hashed, multi-level, data object to the highest-level hashed data object generated to determine the validity of the hashed, multi-level data object.

154. The method of claim 151 wherein the non-hashed, target data object is a micropayment token.

155. The method of claim 154 wherein the micropayment token is a selected micropayment token.

156. The method of claim 154 wherein the micropayment token is an unselected micropayment token.

157. The method of claim 151 wherein the non-hashed, target data object is an offer package.

158. A computer program product residing on a computer readable medium having a plurality of instructions stored thereon which, when executed by the processor, cause that processor to:
receive a hashed, multi-level, data object, wherein the hashed, multi-level, data object includes one or more hashed, non-target data objects;
receive one or more sequential data keys, wherein each sequential data key corresponds to a hashed, non-target data object at a unique level within the hashed, multi-level, data object;
receive a non-hashed, target data object;
hash the non-hashed, target data object to generate an N^{th} level hashed data object;
group the N^{th} level hashed data object with an N^{th} level, sequential data key to generate an N^{th} level object/key pair; and
hash the N^{th} level object/key pair to generate an N^{th+1} level hashed data object;
wherein grouping the N^{th} level hashed data object and hashing the N^{th} level object/key pair are repeated for each sequential data key.

159. The computer program product of claim 158 wherein the hashed, multi-level, data object is an encrypted, hashed, multi-level, data object, the computer program product further comprising instructions for:
decrypting the encrypted, hashed, multi-level, data object to generate a decrypted, hashed, multi-level, data object.

160. The computer program product of claim 159 further comprising instructions for:
comparing the decrypted, hashed, multi-level, data object to the highest-level hashed data object generated to determine the validity of the hashed, multi-level data object.

161. The computer program product of claim 158 wherein the non-hashed, target data object is a micropayment token.

162. The computer program product of claim 161 wherein the micropayment token is a selected micropayment token.

163. The computer program product of claim 161 wherein the micropayment token is an unselected micropayment token.

164. The computer program product of claim 158 wherein the non-hashed, target data object is an offer package.

165-220. (canceled)
